(19) United States
(12) Patent Application Publication
(10) Pub. No.: US 2022/0334353 A1
(43) Pub. Date: Oct. 20, 2022

(54) Optical Imaging Lens Assembly

(71) Applicant: ZHEJIANG SUNNY OPTICS CO., LTD., Ningbo, Zhejiang (CN)

(72) Inventors: Shuang ZHANG, Ningbo, Zhejiang (CN); Xiaobin ZHANG, Ningbo, Zhejiang (CN); Fujian DAI, Ningbo, Zhejiang (CN); Liefeng ZHAO, Ningbo, Zhejiang (CN)

(21) Appl. No.: 17/641,108

(22) PCT Filed: Sep. 3, 2020
(86) PCT No.: PCT/CN2020/113227

§ 371 Date: Mar. 8, 2022

(30) Foreign Application Priority Data
Oct. 29, 2019 (CN) 201911035711.1

(51) Int. Cl. G02B 9/60

(52) U.S. Cl. CPC G02B 9/60

(57) ABSTRACT

The disclosure provides an optical imaging lens assembly, which sequentially includes from an object side to an image side along an optical axis: a first lens with a positive refractive power, an object-side surface thereof is a convex surface, and an image-side surface thereof is a concave surface; a second lens with a negative refractive power; a third lens with a refractive power; a fourth lens with a positive refractive power; and a fifth lens with a negative refractive power; VP is an on-axis distance from an intersection point of a straight line where a marginal ray of the optical imaging lens assembly is located and the optical axis to the object-side surface of the first lens, and VP satisfies 0 mm<VP<1.5 mm.

### CROSS-REFERENCE TO RELATED APPLICATION

The disclosure claims priority to and the benefit of Chinese Patent Application No. 201911035711.1, filed to the China National Intellectual Property Administration (CHIPA) on 29 Oct. 2019, which is hereby incorporated by reference in its entirety.

### TECHNICAL FIELD

The disclosure relates to the technical field of optical elements, and more particularly to an optical imaging lens assembly.

### BACKGROUND

In recent years, with the upgrading and updating of consumer electronic products and the development of image software functions and video software functions in consumer electronic products, market requirements on optical imaging lens assemblies applicable to portable electronic products have been gradually increased. For example, market requirements for full-screen mobile phones have been continuously increased.

A screen in a full-screen mobile phone occupies a relatively large mounting space of the mobile phone. As a result, mounting spaces for other fittings of the mobile phone are reduced. A mounting space for a front-facing camera is increasingly limited. In order to satisfy a miniaturization requirement and an imaging requirement, there is a need for an optical imaging lens assembly which is miniature, small in head size and high in manufacturability and image quality.

### SUMMARY

The disclosure provides an optical imaging lens assembly applicable to a portable electronic product and capable of at least overcoming or partially overcoming at least one shortcoming in the related art.

An embodiment of the disclosure provides an optical imaging lens assembly, which sequentially includes from an object side to an image side along an optical axis: a first lens with a positive refractive power, an object-side surface thereof may be a convex surface, and an image-side surface thereof be a concave surface; a second lens with a negative refractive power; a third lens with a refractive power; a fourth lens with a positive refractive power; and a fifth lens with a negative refractive power.

In an implementation mode, VP is an on-axis distance from an intersection point of a straight line where a marginal ray of the optical imaging lens assembly is located and the optical axis to the object-side surface of the first lens, and VP may satisfy 0 mm<VP<1.5 mm.

In an implementation mode, an effective focal length f4 of the fourth lens and an effective focal length f1 of the first lens may satisfy 1.0<f4/f1<1.4.

In an implementation mode, an effective focal length f2 of the second lens, an effective focal length f5 of the fifth lens and a total effective focal length f of the optical imaging lens assembly may satisfy 1.4<(f5−f2)/f<1.8.

In an implementation mode, TTL is a distance from the object-side surface of the first lens to an imaging surface of the optical imaging lens assembly on the optical axis, ImgH is a half of a diagonal length of an effective pixel region on the imaging surface, and TTL and ImgH may satisfy TTL/ImgH<1.3.

In an implementation mode, FOV is a maximum field of view of the optical imaging lens assembly, and FOV may satisfy 82°<FOV<87°.

In an implementation mode, EPD is an Entrance Pupil Diameter of the optical imaging lens assembly, ImgH is a half of a diagonal length of an effective pixel region on an imaging surface of the optical imaging lens assembly, and EPD and ImgH may satisfy 0.4<EPD/ImgH<0.6.

In an implementation mode, a curvature radius R1 of the object-side surface of the first lens, a curvature radius R2 of the image-side surface of the first lens, a curvature radius R3 of an object-side surface of the second lens and a curvature radius R4 of an image-side surface of the second lens may satisfy 1.9<(R3+R4)/(R1+R2)<2.6.

In an implementation mode, a total effective focal length f of the optical imaging lens assembly, a curvature radius R8 of an image-side surface of the fourth lens and a curvature radius R10 of an image-side surface of the fifth lens may satisfy 0.7<(R10−R8)/f<1.2.

In an implementation mode, a spacing distance T34 of the third lens and the fourth lens on the optical axis, a center thickness CT4 of the fourth lens on the optical axis, a spacing distance T45 of the fourth lens and the fifth lens on the optical axis and a center thickness CT5 of the fifth lens on the optical axis may satisfy 1.0<(T34+CT4)/(T45+CT5)<1.3.

In an implementation mode, ImgH is a half of a diagonal length of an effective pixel region on an imaging surface of the optical imaging lens assembly, and an effective semi-diameter DT11 of the object-side surface of the first lens and ImgH may satisfy 2.3<10×DT11/ImgH<2.8.

In an implementation mode, a combined focal length f12 of the first lens and the second lens, a center thickness CT1 of the first lens on the optical axis and a center thickness CT2 of the second lens on the optical axis may satisfy 6.0<f12/ (CT1+CT2)<6.5.

In an implementation mode, a window diameter DW of the optical imaging lens assembly may satisfy 1.5 mm<DW<2.0 mm.

In an implementation mode, SAG51 is an on-axis distance from an intersection point of an object-side surface of the fifth lens and the optical axis to an effective radius vertex of the object-side surface of the fifth lens, SAG52 is an on-axis distance from an intersection point of an image-side surface of the fifth lens and the optical axis to an effective radius vertex of the image-side surface of the fifth lens, and SAG51 and SAG52 may satisfy 0.7<SAG52/SAG51<0.9.

According to the disclosure, the five lenses are adopted, and the refractive powers and surface types of each lens, the center thicknesses of each lens, on-axis spacing distances between the lenses and the like are reasonably configured to achieve at least one of the beneficial effects of small head size, high manufacturability, high image quality and the like of the optical imaging lens assembly.

### BRIEF DESCRIPTION OF THE DRAWINGS

Detailed descriptions are made to the following nonrestrictive embodiments below in combination with the drawings to make the other features, objectives and advantages of the disclosure more apparent. In the drawings:

FIG. 1 shows a schematic light path diagram of an optical imaging lens assembly according to the disclosure;

FIG. 2 shows a structural schematic diagram of an optical imaging lens assembly according to Embodiment 1 of the disclosure; and

FIGS. 3A-3D show a longitudinal aberration curve, an astigmatism curve, a distortion curve and a lateral color curve of an optical imaging lens assembly according to Embodiment 1 respectively;

FIG. 4 shows a structural schematic diagram of an optical imaging lens assembly according to Embodiment 2 of the disclosure; and

FIGS. 5A-5D show a longitudinal aberration curve, an astigmatism curve, a distortion curve and a lateral color curve of an optical imaging lens assembly according to Embodiment 2 respectively;

FIG. 6 shows a structural schematic diagram of an optical imaging lens assembly according to Embodiment 3 of the disclosure; and

FIGS. 7A-7D show a longitudinal aberration curve, an astigmatism curve, a distortion curve and a lateral color curve of an optical imaging lens assembly according to Embodiment 3 respectively;

FIG. 8 shows a structural schematic diagram of an optical imaging lens assembly according to Embodiment 4 of the disclosure; and

FIGS. 9A-9D show a longitudinal aberration curve, an astigmatism curve, a distortion curve and a lateral color curve of an optical imaging lens assembly according to Embodiment 4 respectively;

FIG. 10 shows a structural schematic diagram of an optical imaging lens assembly according to Embodiment 5 of the disclosure; and

FIGS. 11A-11D show a longitudinal aberration curve, an astigmatism curve, a distortion curve and a lateral color curve of an optical imaging lens assembly according to Embodiment 5 respectively;

FIG. 12 shows a structural schematic diagram of an optical imaging lens assembly according to Embodiment 6 of the disclosure; and

FIGS. 13A-13D show a longitudinal aberration curve, an astigmatism curve, a distortion curve and a lateral color curve of an optical imaging lens assembly according to Embodiment 6 respectively.

### DETAILED DESCRIPTION OF THE EMBODIMENTS

In order to understand the disclosure better, more detailed descriptions will be made to each aspect of the disclosure with reference to the drawings. It is to be understood that these detailed descriptions are only descriptions about the exemplary embodiments of the disclosure and not intended to limit the scope of the disclosure in any manner. In the whole specification, the same reference sign numbers represent the same components. Expression “and/or” includes any or all combinations of one or more in associated items that are listed.

It should be noted that, in this description, expressions first, second, third and the like are only used to distinguish one feature from another feature and do not represent any limitation to the feature. Thus, a first lens discussed below could also be referred to as a second lens or a third lens without departing from the teachings of the disclosure.

In the drawings, the thickness, size and shape of the lens have been slightly exaggerated for ease illustration. In particular, a spherical shape or aspheric shape shown in the drawings is shown by some embodiments. That is, the spherical shape or the aspheric shape is not limited to the spherical shape or aspheric shape shown in the drawings. The drawings are by way of example only and not strictly to scale.

Herein, a paraxial region refers to a region nearby an optical axis. If a lens surface is a convex surface and a position of the convex surface is not defined, it indicates that the lens surface is a convex surface at least in the paraxial region; and if a lens surface is a concave surface and a position of the concave surface is not defined, it indicates that the lens surface is a concave surface at least in the paraxial region. A surface, closest to a shot object, of each lens is called an object-side surface of the lens, and a surface, closest to an imaging surface, of each lens is called an image-side surface of the lens.

It should also be understood that terms “include”, “including”, “have”, “contain”, and/or “containing”, used in the specification, represent existence of a stated feature, component and/or part but do not exclude existence or addition of one or more other features, components and parts and/or combinations thereof. In addition, expressions like “at least one in . . . ” may appear after a list of listed characteristics not to modify an individual component in the list but to modify the listed characteristics. Moreover, when the embodiments of the disclosure are described, “may” is used to represent “one or more embodiments of the disclosure”. Furthermore, term “exemplary” refers to an example or exemplary description.

Unless otherwise defined, all terms (including technical terms and scientific terms) used in the disclosure have the same meanings as commonly understood by those of ordinary skill in the art of the disclosure. It should also be understood that the terms (for example, terms defined in a common dictionary) should be explained to have the same meanings as those in the context of a related art and may not be explained with ideal or excessively formal meanings, unless clearly defined like this in the disclosure.

It is to be noted that the embodiments in the disclosure and features in the embodiments may be combined without conflicts. The disclosure will be described below with reference to the drawings and in combination with the embodiments in detail.

The features, principles and other aspects of the disclosure will be described below in detail.

An optical imaging lens assembly according to an exemplary embodiment of the disclosure may include, for example, five lenses with refractive powers, i.e., a first lens, a second lens, a third lens, a fourth lens and a fifth lens. The five lenses are sequentially arranged from an object side to an image side along an optical axis. There may be an air space between any two adjacent lenses in the first lens to the fifth lens.

In the exemplary embodiment, the first lens has a positive refractive power, and an object-side surface thereof may be a convex surface, and an image-side surface thereof may be a concave surface; the second lens has a negative refractive power; the third lens has a positive refractive power or a negative refractive power; the fourth lens has a positive refractive power; and the fifth lens has a negative refractive power. The configuration of the positive and negative refractive powers of each component of the lens and curvatures of surface types of the lenses are controlled reasonably to balance a low-order aberration of the lens effectively.

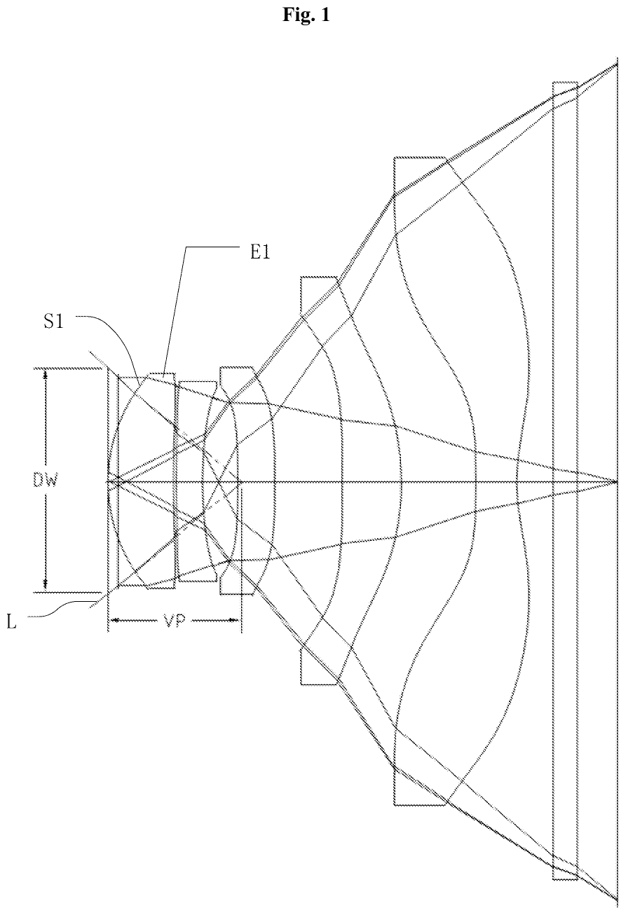

In the exemplary embodiment, referring to FIG. 1, the optical imaging lens assembly of the disclosure may satisfy a conditional expression 0 mm<VP<1.5 mm, wherein VP is an on-axis distance from an intersection point of a straight line where a marginal ray L of the optical imaging lens assembly is located and the optical axis to the object-side surface S1 of the first lens E1. FIG. 1 schematically shows multiple light paths in a meridian surface. Different light paths have different incident rays in an object side direction of the object-side surface S1 of the first lens E1, wherein extension lines of two marginal rays intersect the optical axis at the same point. More specifically, VP may satisfy 1.01 mm<VP<1.11 mm. A depth of an intersection point of an extension line of the marginal ray L at an object-side end of the optical imaging lens assembly is controlled to help to limit a window size of the optical imaging lens assembly. The optical imaging lens assembly of the disclosure may be applied to a device with a requirement for a small window size.

In the exemplary embodiment, the optical imaging lens assembly of the disclosure may satisfy a conditional expression 1.0<f4/f1<1.4, wherein f4 is an effective focal length of the fourth lens, and f1 is an effective focal length of the first lens. More specifically, f4 and f1 may satisfy 1.10<f4/f1<1.35. A ratio of the effective focal length of the fourth lens to the effective focal length of the first lens is controlled to help to reduce an aberration of the optical imaging lens assembly and ensure a relatively gentle light path of the optical imaging lens assembly, such that a light deflection angle may be reduced to ensure the gentle emission of light to further facilitate the reduction of the sensitivity of the optical imaging lens assembly.

In the exemplary embodiment, the optical imaging lens assembly of the disclosure may satisfy a conditional expression 1.4<(f5−f2)/f<1.8, wherein f2 is an effective focal length of the second lens, f5 is an effective focal length of the fifth lens, and f is a total effective focal length of the optical imaging lens assembly. More specifically, f2, f5 and f may satisfy 1.45<(f5−f2)/f<1.78. The effective focal length of the fifth lens and the effective focal length of the second lens are matched with the total effective focal length, so that the fifth lens and the second lens have proper refractive powers, which contributes to balancing an aberration of the optical imaging lens assembly, may reduce an overall light deflection degree of the fifth lens, and also contributes to reducing local blurriness in an inner field of view and improving the imaging performance of the optical imaging lens assembly.

In the exemplary embodiment, the optical imaging lens assembly of the disclosure may satisfy a conditional expression TTL/ImgH<1.3, wherein TTL is a distance from the object-side surface of the first lens to an imaging surface of the optical imaging lens assembly on the optical axis, and ImgH is a half of a diagonal length of an effective pixel region on the imaging surface. More specifically, TTL and ImgH may satisfy 1.20<TTL/ImgH<1.29. A ratio of an optical total length of the optical imaging lens assembly to an image height of the optical imaging lens assembly is controlled to help to reduce a structure size of the optical imaging lens assembly to achieve a feature of ultra-thin miniaturization of the optical imaging lens assembly. The optical imaging lens assembly of the disclosure is applicable to various miniaturized photographic devices.

In the exemplary embodiment, the optical imaging lens assembly of the disclosure may satisfy a conditional expression 82°<FOV<87°, wherein FOV is a maximum field of view of the optical imaging lens assembly. More specifically, FOV may satisfy 83.9°<FOV<85.6°. The maximum field of view of the optical imaging lens assembly is controlled to help to enlarge a field of vision of the optical imaging lens assembly and ensure a large imaging space of the optical imaging system, and help to reduce a numerical value of VP to further facilitate the reduction of a window diameter of the optical imaging lens assembly.

In the exemplary embodiment, the optical imaging lens assembly of the disclosure may satisfy a conditional expression 0.4<EPD/ImgH<0.6, wherein EPD is an Entrance Pupil Diameter of the optical imaging lens assembly, and ImgH is a half of a diagonal length of an effective pixel region on an imaging surface of the optical imaging lens assembly. More specifically, EPD and ImgH may satisfy 0.48<EPD/ImgH<0.53. A ratio of the Entrance Pupil Diameter of the optical imaging lens assembly to an image height of the optical imaging lens assembly is controlled to help to improve a relative aperture of the optical imaging lens assembly and further increase a luminous flux of the optical imaging lens assembly to facilitate the improvement of illuminance of the optical imaging lens assembly.

In the exemplary embodiment, the optical imaging lens assembly of the disclosure may satisfy a conditional expression 1.9<(R3+R4)/(R1+R2)<2.6, wherein R1 is a curvature radius of the object-side surface of the first lens, R2 is a curvature radius of the image-side surface of the first lens, R3 is a curvature radius of an object-side surface of the second lens, and R4 is a curvature radius of an image-side surface of the second lens. More specifically, R1, R2, R3 and R4 may satisfy 1.97<(R3+R4)/(R1+R2)<2.54. The curvature radii of the two mirror surfaces of the first lens are matched with the curvature radii of the two mirror surfaces of the second lens to help to correct a chromatic aberration and spherical aberration of the optical imaging lens assembly better to further improve the imaging quality of the optical imaging lens assembly.

In the exemplary embodiment, the optical imaging lens assembly of the disclosure may satisfy a conditional expression 0.7<(R10−R8)/f<1.2, wherein f is a total effective focal length of the optical imaging lens assembly, R8 is a curvature radius of an image-side surface of the fourth lens, and R10 is a curvature radius of an image-side surface of the fifth lens. More specifically, f, R8 and R10 may satisfy 0.8<(R10−R8)/f<1.1. The curvature radius of the image-side surface of the fourth lens and the curvature radius of the image-side surface of the fifth lens are matched with the total effective focal length to help to ensure that the fourth lens and the fifth lens have desired refractive powers to further reduce a deflection angle of light between the fourth lens and the fifth lens, improve a coma of the optical imaging lens assembly and reduce the sensitivity of the optical imaging lens assembly.

In the exemplary embodiment, the optical imaging lens assembly of the disclosure may satisfy a conditional expression 1.0<(T34+CT4)/(T45+CT5)<1.3, wherein T34 is a spacing distance of the third lens and the fourth lens on the optical axis, CT4 is a center thickness of the fourth lens on the optical axis, T45 is a spacing distance of the fourth lens and the fifth lens on the optical axis, and CT5 is a center thickness of the fifth lens on the optical axis. More specifically, T34, CT4, T45 and CT5 may further satisfy 1.05<(T34+CT4)/(T45+CT5)<1.25. Positional relationships between mirror surfaces from an image-side surface of the third lens to an image-side surface of the fifth lens are controlled, so that a field curvature of the optical imaging lens assembly may be corrected effectively, meanwhile, the improvement of the manufacturability of the optical imaging lens assembly and the reduction of the sensitivity of the optical imaging lens assembly are facilitated, and furthermore, the field curvature is easily corrected after each lens is assembled.

In the exemplary embodiment, the optical imaging lens assembly of the disclosure may satisfy a conditional expression 2.3<10×DT11/ImgH<2.8, wherein DT11 is an effective semi-diameter of the object-side surface of the first lens, and ImgH is a half of a diagonal length of an effective pixel region on an imaging surface of the optical imaging lens assembly. More specifically, DT11 and ImgH may satisfy 2.45<10×DT11/ImgH<2.65. A ratio of the effective semi-diameter of the object-side surface of the first lens to an image height of the object-side surface of the first lens is controlled to help to control a size of an object-side end of the optical imaging lens assembly and enlarge an imaging range of an object space of the optical imaging lens assembly to achieve a feature of large image surface of the optical imaging lens assembly. Exemplarily, when the optical imaging lens assembly satisfies TTL/ImgH <1.3 at the same time, the optical imaging lens assembly is favorably miniaturized and endowed with a large image surface, and is suitable for being mounted in a miniaturized photographic device.

In the exemplary embodiment, the optical imaging lens assembly of the disclosure may satisfy a conditional expression 6.0<f12/(CT1+CT2)<6.5, wherein f12 is a combined focal length of the first lens and the second lens, CT1 is a center thickness of the first lens on the optical axis, and CT2 is a center thickness CT2 of the second lens on the optical axis. More specifically, f12, CT1 and CT2 may further satisfy 6.02<f12/(CT1+CT2)<6.18. The center thicknesses of the first lens and the second lens are matched with the combined focal length thereof to help to reduce the sensitivities of the first lens and the second lens and correct spherochromatic aberration and astigmatism of the optical imaging lens assembly.

In the exemplary embodiment, referring to FIG. 1, the optical imaging lens assembly of the disclosure may satisfy a conditional expression 1.5 mm<DW<2.0 mm, wherein DW is a window diameter of the optical imaging lens assembly. DW may be calculated through a conditional expression DW=2×VP×tan(0.5×FOV), wherein VP is an on-axis distance from an intersection point of a straight line where a marginal ray of the optical imaging lens assembly is located and the optical axis to the object-side surface S1 of the first lens E1, and FOV is a maximum FOV of the optical imaging lens assembly. More specifically, DW may satisfy 1.90 mm<DW<1.99 mm. The window diameter of a window is limited to help to reduce a head size of the optical imaging lens assembly. After the optical imaging lens assembly of the embodiment is mounted to a device, the device may achieve a relatively large field of view by a relatively small window. For example, after the optical imaging lens assembly is mounted to a mobile phone, an opening of a screen of the mobile phone is relatively small, and a screen-to-body ratio of the mobile phone is increased.

In the exemplary embodiment, the optical imaging lens assembly of the disclosure may satisfy a conditional expression 0.7<SAG52/SAG51<0.9, wherein SAG51 is an on-axis distance from an intersection point of an object-side surface of the fifth lens and the optical axis to an effective radius vertex of the object-side surface of the fifth lens, and SAG52 is an on-axis distance from an intersection point of an image-side surface of the fifth lens and the optical axis to an effective radius vertex of the image-side surface of the fifth lens. More specifically, SAG51 and SAG52 may satisfy 0.76<SAG52/SAG51<0.89. A ratio of vector heights of two lateral surfaces of the fifth lens is controlled, so that a surface type of the fifth lens may be controlled relatively well, a bending degree of the fifth lens may be reduced, a manufacturability of the fifth lens during forming is further improved, and in addition, local blurriness of the optical imaging lens may be improved.

In the exemplary embodiment, the optical imaging lens assembly may further include at least one diaphragm. The diaphragm may be arranged at a proper position as required, for example, arranged between the object side and the first lens. In an embodiment, the optical imaging lens assembly may further include an optical filter configured to correct the chromatic aberration and/or a protective glass configured to protect a photosensitive element on the imaging surface.

The optical imaging lens assembly according to the embodiment of the disclosure may adopt multiple lenses, for example, the above-mentioned five lenses. The refractive powers and surface types of each lens, the center thickness of each lens, on-axis spacing distances between the lenses and the like are reasonably configured to effectively reduce the size of the imaging lens assembly, reduce the sensitivity of the imaging lens assembly, improve the machinability of the imaging lens assembly and ensure that the optical imaging lens assembly is more favorable for production and machining and applicable to a portable electronic product. In addition, the optical imaging lens assembly of the disclosure has the high optical performance of small head size, high manufacturability, high image quality and the like.

In an embodiment of the disclosure, at least one of mirror surfaces of each lens is an aspheric mirror surface, namely at least one of the object-side surface of the first lens to an image-side surface of the fifth lens is an aspheric mirror surface. An aspheric lens has a feature that a curvature keeps changing from a center of the lens to a periphery of the lens. Unlike a spherical lens with a constant curvature from a center of the lens to a periphery of the lens, the aspheric lens has a better curvature radius feature and the advantages of improving distortions and improving astigmatism aberrations. With the adoption of the aspheric lens, astigmatism aberrations during imaging may be eliminated as much as possible, thereby improving the imaging quality. In an embodiment, at least one of the object-side surface and the image-side surface of each lens in the first lens, the second lens, the third lens, the fourth lens and the fifth lens is an aspheric mirror surface. In another embodiment, both the object-side surface and the image-side surface of each lens in the first lens, the second lens, the third lens, the fourth lens and the fifth lens are aspheric mirror surfaces.

However, those skilled in the art should know that the number of the lenses forming the optical imaging lens assembly may be changed without departing from the technical solutions claimed in the disclosure to achieve each result and advantage described in the specification. For example, although descriptions are made in the embodiment with five lenses as an example, the optical imaging lens assembly is not limited to five lenses. If necessary, the optical imaging lens assembly may also include another number of lenses.

Specific embodiments applicable to the optical imaging lens assembly of the above-mentioned implementation mode will further be described below with reference to the drawings.

### Embodiment 1

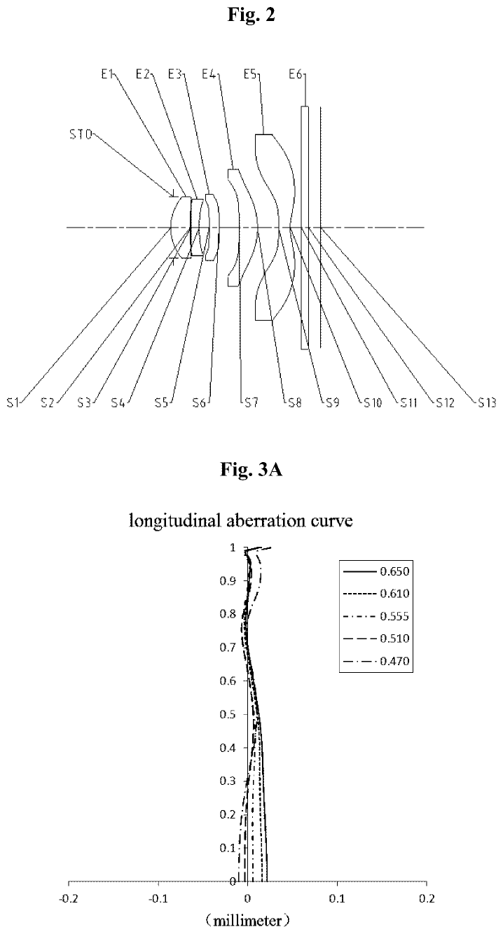

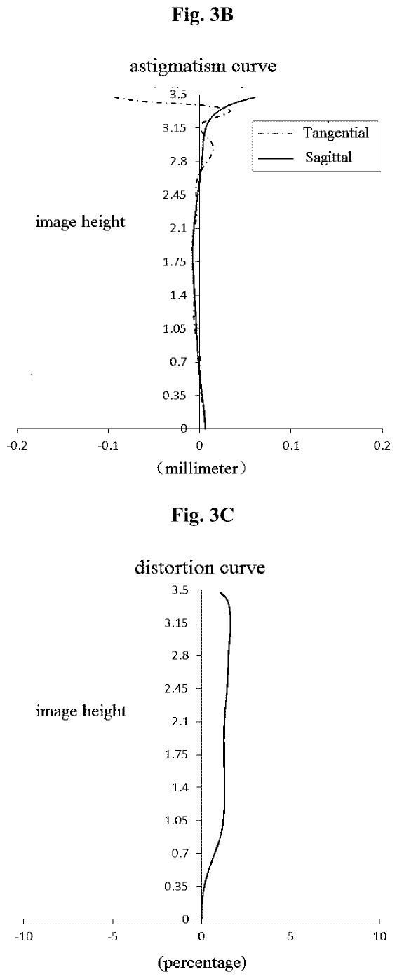

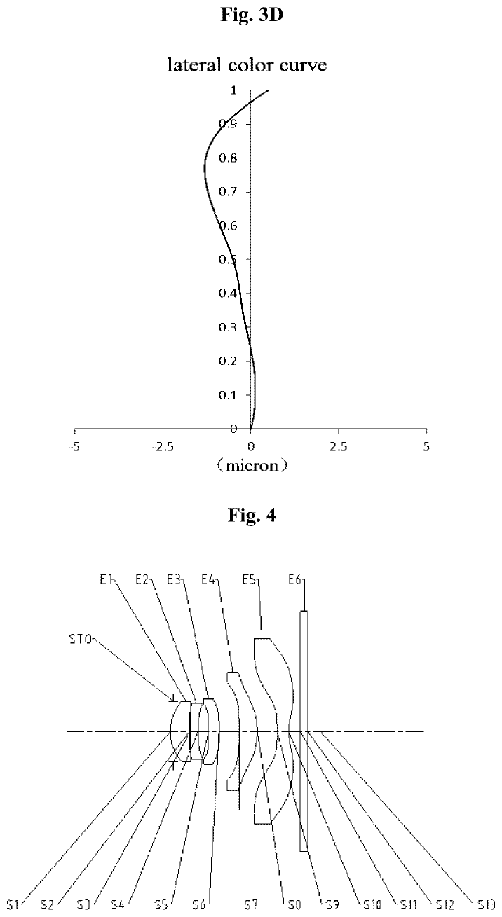

An optical imaging lens assembly according to Embodiment 1 of the disclosure will be described below with reference to FIGS. 2-3D. FIG. 2 shows a structural schematic diagram of an optical imaging lens assembly according to Embodiment 1 of the disclosure.

As shown in FIG. 2, the optical imaging lens assembly sequentially includes from an object side to an image side along an optical axis: a diaphragm STO, a first lens E1, a second lens E2, a third lens E3, a fourth lens E4, a fifth lens E5 and an optical filter E6.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a convex surface. The fourth lens E4 has a positive refractive power, an object-side surface S7 thereof is a concave surface, and an image-side surface S8 thereof is a convex surface. The fifth lens E5 has a negative refractive power, an object-side surface S9 thereof is a concave surface, and an image-side surface S10 thereof is a concave surface. The optical filter E6 has an object-side surface S11 and an image-side surface S12. The optical imaging lens has an imaging surface S13. Light from an object sequentially passes through each of the surfaces S1 to S12 and is finally imaged on the imaging surface S13.

Table 1 shows a basic parameter table of the optical imaging lens assembly of Embodiment 1, wherein the units of the curvature radius, the thickness/distance and the focal length are all millimeters (mm).

TABLE 1

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −0.0851 | | | | |
| S1 | Aspheric | 1.3691 | 0.5615 | 1.55 | 56.1 | 3.45 | −0.3413 |
| S2 | Aspheric | 4.2727 | 0.0244 | | | | −17.8757 |
| S3 | Aspheric | 7.7524 | 0.2399 | 1.68 | 19.2 | −9.10 | 3.5284 |
| S4 | Aspheric | 3.3909 | 0.2882 | | | | 13.0187 |
| S5 | Aspheric | 20.2530 | 0.2888 | 1.55 | 56.1 | 36.38 | 13.0148 |
| S6 | Aspheric | −1015.3300 | 0.5800 | | | | −96.0000 |
| S7 | Aspheric | −16.4982 | 0.5318 | 1.55 | 56.1 | 3.96 | 49.0942 |
| S8 | Aspheric | −1.9348 | 0.6077 | | | | −12.5407 |
| S9 | Aspheric | −1448.2200 | 0.3395 | 1.54 | 55.7 | −2.61 | 48.3965 |
| S10 | Aspheric | 1.4036 | 0.3238 | | | | −7.1369 |
| S11 | Spherical | Infinite | 0.2100 | 1.52 | 64.2 | | |
| S12 | Spherical | Infinite | 0.3542 | | | | |
| S13 | Spherical | Infinite | | | | | |

In Embodiment 1, a value of a total effective focal length f of the optical imaging lens assembly is 3.76 mm. TTL is an on-axis distance from the object-side surface S1 of the first lens E1 to the imaging surface S13, and a value of TTL is 4.35 mm. ImgH is a half of a diagonal length of an effective pixel region on the imaging surface S13, and a value of ImgH is 3.48 mm.

In Embodiment 1, both the object-side surface and the image-side surface of any lens in the first lens E1 to the fifth lens E5 are aspheric surfaces, and a surface type x of each aspheric lens may be defined through, but not limited to, the following aspheric surface formula:

$$x = \frac{c {h}^{3}}{1 + \sqrt{1 - ( k + 1 ) {c}^{2} {h}^{2}}} + \sum {Aih}^{\text{?}} \qquad ( 1 )$$

$$\text{?} \text{indicates text missing or illegible when filed}$$

wherein x is a vector height of a distance between the aspheric surface and a vertex of the aspheric surface when the aspheric surface is located at a position with the height h in an optical axis direction; c is a paraxial curvature of the aspheric surface, c=1/R (namely, the paraxial curvature c is a reciprocal of the curvature radius R in Table 1 above); k is a conic coefficient; and Ai is a correction coefficient of the i-th order of the aspheric surface. Table 2 shows high-order coefficients A4, A6, A8, A10, A12, A14, A16, A18 and A20 that may be used for each of the aspheric mirror surfaces S1-S10 in Embodiment 1.

TABLE 2

| Surface number | A4 | A6 | A8 | A10 | A12 |
|---|---|---|---|---|---|
| S1 | 1.5654E−02 | 1.1879E−01 | −9.3538E−01 | 4.8395E+00 | −1.5241E+01 |
| S2 | −2.8477E−01 | −3.6288E−01 | 9.6175E+00 | −5.7412E+01 | 2.2200E+02 |
| S3 | −2.9724E−01 | −2.5888E−01 | 1.0204E+01 | −6.0563E+01 | 2.2395E+02 |
| S4 | −1.4076E−01 | 8.9454E−01 | −5.8018E+00 | 3.4871E+01 | −1.3947E+02 |
| S5 | −3.6510E−01 | 1.4125E+00 | −1.3083E+01 | 7.5650E+01 | −2.8018E+02 |
| S6 | −2.6628E−01 | 6.8883E−01 | −4.7603E+00 | 1.9819E+01 | −5.2257E+01 |
| S7 | −2.2200E−02 | −1.0300E−02 | −2.4615E−01 | 6.3625E−01 | −8.0420E−01 |
| S8 | −1.6087E−01 | 2.1605E−01 | −3.8322E−01 | 4.9884E−01 | −3.9469E−01 |
| S9 | −3.5287E−01 | 1.6206E−01 | 5.9610E−03 | −2.9770E−02 | 1.2204E−02 |
| S10 | −1.8040E−01 | 1.0427E−01 | −3.9030E−02 | 9.3210E−03 | −1.3100E−03 |
| | Surface number | A14 | A16 | A18 | A20 |
| | S1 | 2.9909E+01 | −3.5942E+01 | 2.4194E+01 | −7.0174E+00 |
| | S2 | −5.6098E+02 | 8.4800E+02 | −6.8556E+02 | 2.2702E+02 |
| | S3 | −5.4153E+02 | 7.9460E+02 | −6.3043E+02 | 2.0616E+02 |
| | S4 | 3.4691E+02 | −5.2221E+02 | 4.3776E+02 | −1.5702E+02 |
| | S5 | 6.5500E+02 | −9.3599E+02 | 7.4379E+02 | −2.5066E+02 |
| | S6 | 8.6783E+01 | −8.7981E+01 | 4.9656E+01 | −1.1851E+01 |
| | S7 | 5.7983E−01 | −2.4706E−01 | 5.9642E−02 | −6.4000E−03 |
| | S8 | 1.9234E−01 | −5.6960E−02 | 9.4240E−03 | −6.7000E−04 |
| | S9 | −2.5300E−03 | 2.9800E−04 | −1.9000E−05 | 4.8900E−07 |
| | S10 | 7.3400E−05 | 5.3200E−06 | −9.8000E−07 | 3.9800E−08 |

FIG. 3A shows a longitudinal aberration curve of the optical imaging lens assembly according to Embodiment 1 to represent deviations of a convergence focal point after lights with different wavelengths passes through the lens. FIG. 3B shows an astigmatism curve of the optical imaging lens assembly according to Embodiment 1 to represent a tangential image surface curvature and a sagittal image surface curvature. FIG. 3C shows a distortion curve of the optical imaging lens assembly according to Embodiment 1 to represent distortion values corresponding to different image heights. FIG. 3D shows a lateral color curve of the optical imaging lens assembly according to Embodiment 1 to represent deviations of different image heights on the imaging surface after the light passes through the lens. According to FIGS. 3A-3D, it can be seen that the optical imaging lens assembly provided in Embodiment 1 may achieve high imaging quality.

### Embodiment 2

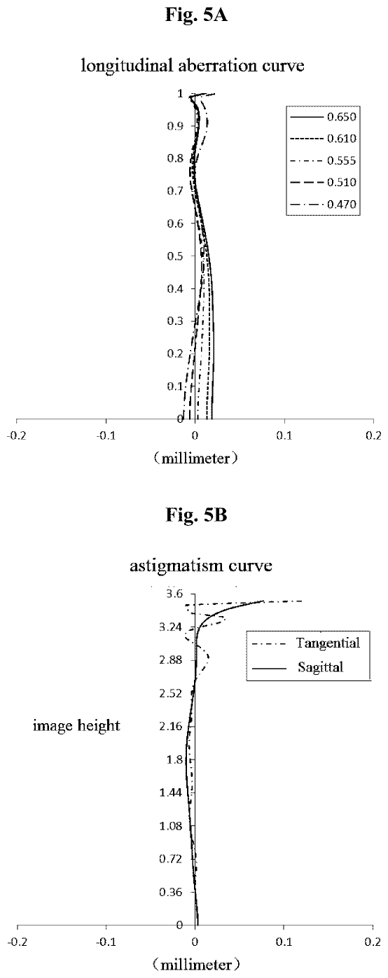

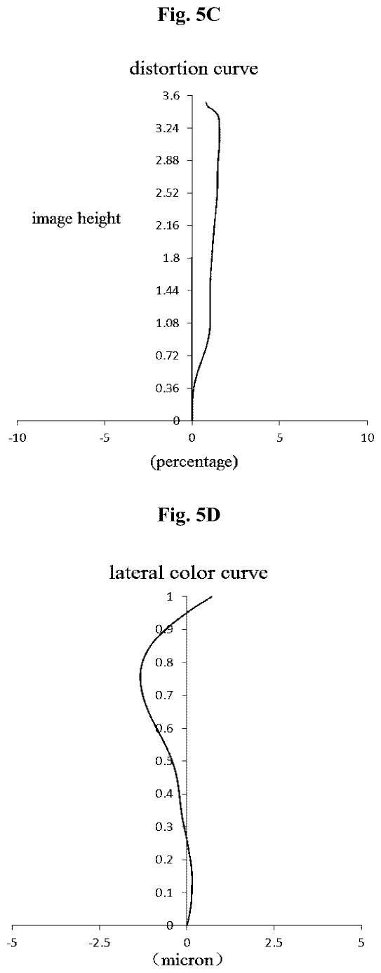

An optical imaging lens assembly according to Embodiment 2 of the disclosure will be described below with reference to FIGS. 4-5D. In the embodiment and the following embodiments, parts of descriptions similar to those about Embodiment 1 are omitted for simplicity. FIG. 4 shows a structural schematic diagram of an optical imaging lens assembly according to Embodiment 2 of the disclosure.

As shown in FIG. 4, the optical imaging lens assembly sequentially includes from an object side to an image side along an optical axis: a diaphragm STO, a first lens E1, a second lens E2, a third lens E3, a fourth lens E4, a fifth lens E5 and an optical filter E6.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a concave surface, and an image-side surface S6 thereof is a convex surface. The fourth lens E4 has a positive refractive power, an object-side surface S7 thereof is a concave surface, and an image-side surface S8 thereof is a convex surface. The fifth lens E5 has a negative refractive power, an object-side surface S9 thereof is a convex surface, and an image-side surface S10 thereof is a concave surface. The optical filter E6 has an object-side surface S11 and an image-side surface S12. The optical imaging lens assembly has an imaging surface S13. Light from an object sequentially passes through each of the surfaces S1 to S12 and is finally imaged on the imaging surface S13.

In Embodiment 2, a value of a total effective focal length f of the optical imaging lens is 3.76 mm. TTL is an on-axis distance from the object-side surface S1 of the first lens E1 to the imaging surface S13, and a value of TTL is 4.35 mm. ImgH is a half of a diagonal length of an effective pixel region on the imaging surface S13, and a value of ImgH is 3.53 mm.

Table 3 shows a basic parameter table of the optical imaging lens assembly of Embodiment 2, wherein the units of the curvature radius, the thickness/distance and the focal length are all millimeters (mm). Table 4 shows high-order coefficients that may be used for each aspheric mirror surface in Embodiment 2. A surface type of each aspheric surface may be defined by formula (1) given in Embodiment 1.

TABLE 3

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −0.0869 | | | | |
| S1 | Aspheric | 1.3641 | 0.5572 | 1.55 | 56.1 | 3.39 | −0.3190 |
| S2 | Aspheric | 4.4262 | 0.0283 | | | | −14.9335 |
| S3 | Aspheric | 8.3911 | 0.2182 | 1.68 | 19.2 | −9.17 | 17.8856 |
| S4 | Aspheric | 3.5330 | 0.3004 | | | | 13.7387 |
| S5 | Aspheric | −748.6470 | 0.3051 | 1.55 | 56.1 | 46.55 | 95.0000 |
| S6 | Aspheric | −24.5852 | 0.5800 | | | | −96.0000 |
| S7 | Aspheric | −21.7578 | 0.5295 | 1.55 | 56.1 | 3.84 | −1.0703 |
| S8 | Aspheric | −1.9305 | 0.5748 | | | | −14.2919 |
| S9 | Aspheric | 133.3036 | 0.3370 | 1.54 | 55.7 | −2.57 | 48.3965 |
| S10 | Aspheric | 1.3618 | 0.3395 | | | | −7.7427 |
| S11 | Spherical | Infinite | 0.2100 | 1.52 | 64.2 | | |
| S12 | Spherical | Infinite | 0.3699 | | | | |
| S13 | Spherical | Infinite | | | | | |

TABLE 4

| Surface number | A4 | A6 | A8 | A10 | A12 |
|---|---|---|---|---|---|
| S1 | 1.4224E−02 | 1.6575E−01 | −1.3783E+00 | 7.1757E+00 | −2.2565E+01 |
| S2 | −2.4927E−01 | −2.4999E−01 | 7.6261E+00 | −4.7305E+01 | 1.8591E+02 |
| S3 | −2.6958E−01 | −1.6742E−01 | 8.7503E+00 | −5.3929E+01 | 2.0234E+02 |
| S4 | −1.2528E−01 | 7.6095E−01 | −4.7565E+00 | 3.0153E+01 | −1.2674E+02 |
| S5 | −3.5327E−01 | 1.4224E+00 | −1.3840E+01 | 8.2402E+01 | −3.1141E+02 |
| S6 | −2.5811E−01 | 6.2810E−01 | −4.3378E+00 | 1.7974E+01 | −4.6988E+01 |
| S7 | −3.6490E−02 | 6.1514E−02 | −5.4069E−01 | 1.2567E+00 | −1.5639E+00 |
| S8 | −1.9666E−01 | 3.0469E−01 | −5.5365E−01 | 6.8527E−01 | −5.0362E−01 |
| S9 | −3.8558E−01 | 1.8150E−01 | 1.4814E−02 | −4.3710E−02 | 1.8867E−02 |
| S10 | −1.8300E−01 | 1.0002E−01 | −2.9960E−02 | 3.3730E−03 | 7.5600E−04 |
| | Surface number | A14 | A16 | A18 | A20 |
| | S1 | 4.3921E+01 | −5.1983E+01 | 3.4309E+01 | −9.7283E+00 |
| | S2 | −4.7118E+02 | 7.1333E+02 | −5.7906E+02 | 1.9299E+02 |
| | S3 | −4.8975E+02 | 7.1832E+02 | −5.7136E+02 | 1.8786E+02 |
| | S4 | 3.2819E+02 | −5.1131E+02 | 4.4205E+02 | −1.6300E+02 |
| | S5 | 7.3952E+02 | −1.0705E+03 | 8.6059E+02 | −2.9337E+02 |
| | S6 | 7.7256E+01 | −7.7492E+01 | 4.3291E+01 | −1.0236E+01 |
| | S7 | 1.1551E+00 | −5.0983E−01 | 1.2505E−01 | −1.3140E−02 |
| | S8 | 2.2562E−01 | −6.1320E−02 | 9.3460E−03 | −6.1000E−04 |
| | S9 | −4.2300E−03 | 5.4300E−04 | −3.8000E−05 | 1.1300E−06 |
| | S10 | −3.5000E−04 | 5.7700E−05 | −4.5000E−06 | 1.4200E−07 |

FIG. 5A shows a longitudinal aberration curve of the optical imaging lens assembly according to Embodiment 2 to represent deviations of a convergence focal point after lights with different wavelengths passes through the lens. FIG. 5B shows an astigmatism curve of the optical imaging lens assembly according to Embodiment 2 to represent a tangential image surface curvature and a sagittal image surface curvature. FIG. 5C shows a distortion curve of the optical imaging lens assembly according to Embodiment 2 to represent distortion values corresponding to different image heights. FIG. 5D shows a lateral color curve of the optical imaging lens assembly according to Embodiment 2 to represent deviations of different image heights on the imaging surface after the light passes through the lens. According to FIGS. 5A-5D, it can be seen that the optical imaging lens assembly provided in Embodiment 2 may achieve high imaging quality.

### Embodiment 3

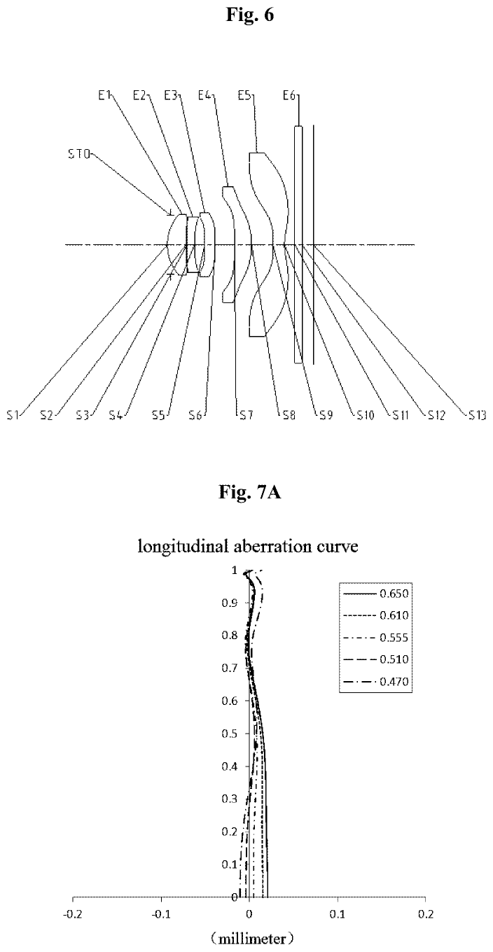

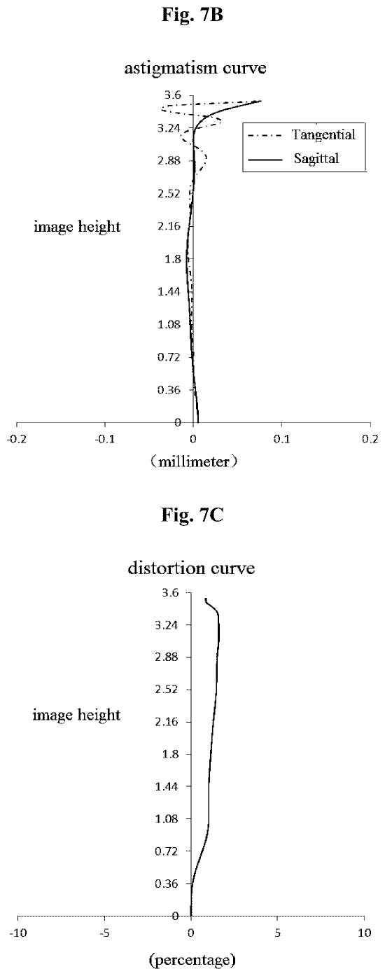

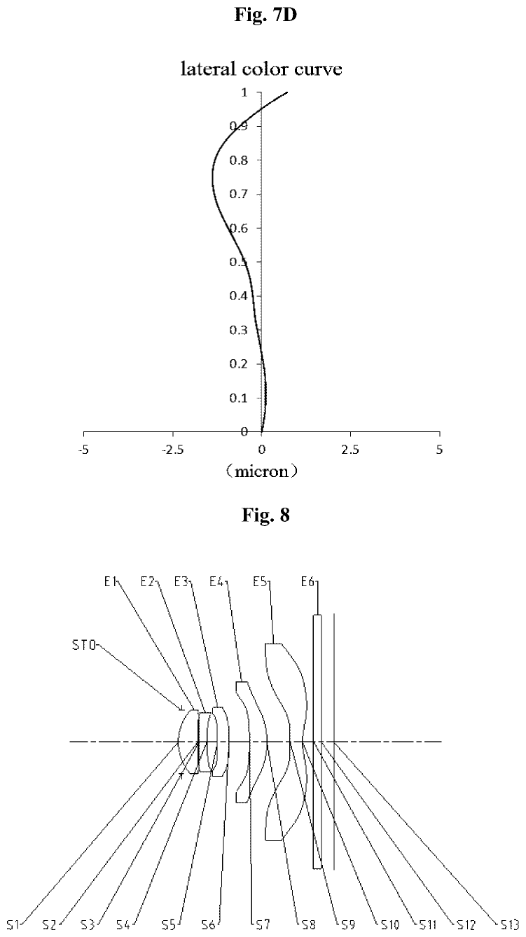

An optical imaging lens assembly according to Embodiment 3 of the disclosure is described below with reference to FIGS. 6-7D. FIG. 6 shows a structural schematic diagram of an optical imaging lens assembly according to Embodiment 3 of the disclosure.

As shown in FIG. 6, the optical imaging lens assembly sequentially includes from an object side to an image side along an optical axis: a diaphragm STO, a first lens E1, a second lens E2, a third lens E3, a fourth lens E4, a fifth lens E5 and an optical filter E6.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a concave surface, and an image-side surface S6 thereof is a convex surface. The fourth lens E4 has a positive refractive power, an object-side surface S7 thereof is a concave surface, and an image-side surface S8 thereof is a convex surface. The fifth lens E5 has a negative refractive power, an object-side surface S9 thereof is a concave surface, and an image-side surface S10 thereof is a concave surface. The optical filter E6 has an object-side surface S11 and an image-side surface S12. The optical imaging lens assembly has an imaging surface S13. Light from an object sequentially passes through each of the surfaces S1 to S12 and is finally imaged on the imaging surface S13.

In Embodiment 3, a value of a total effective focal length f of the optical imaging lens is 3.76 mm. TTL is an on-axis distance from the object-side surface S1 of the first lens E1 to the imaging surface S13, and a value of TTL is 4.32 mm. ImgH is a half of a diagonal length of an effective pixel region on the imaging surface S13, and a value of ImgH is 3.54 mm.

Table 5 shows a basic parameter table of the optical imaging lens assembly of Embodiment 3, wherein the units of the curvature radius, the thickness/distance and the focal length are all millimeters (mm). Table 6 shows high-order coefficients that may be used for each aspheric mirror surface in Embodiment 3. A surface type of each aspheric surface may be defined by formula (1) given in Embodiment 1.

TABLE 5

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −0.0903 | | | | |
| S1 | Aspheric | 1.3531 | 0.5521 | 1.55 | 56.1 | 3.33 | −0.3244 |
| S2 | Aspheric | 4.5195 | 0.0321 | | | | −15.7316 |
| S3 | Aspheric | 9.4809 | 0.2192 | 1.68 | 19.2 | −9.15 | 27.5316 |
| S4 | Aspheric | 3.7137 | 0.3003 | | | | 14.5893 |
| S5 | Aspheric | −41.1563 | 0.3108 | 1.55 | 56.1 | 50.55 | 95.0000 |
| S6 | Aspheric | −16.5638 | 0.5700 | | | | −76.9017 |
| S7 | Aspheric | −33.0652 | 0.5042 | 1.55 | 56.1 | 4.19 | 85.3081 |
| S8 | Aspheric | −2.1516 | 0.6330 | | | | −20.3362 |
| S9 | Aspheric | −36.2916 | 0.3400 | 1.54 | 55.7 | −2.62 | 48.3965 |
| S10 | Aspheric | 1.4650 | 0.3087 | | | | −9.2277 |
| S11 | Spherical | Infinite | 0.2100 | 1.52 | 64.2 | | |
| S12 | Spherical | Infinite | 0.3392 | | | | |
| S13 | Spherical | Infinite | | | | | |

TABLE 6

| Surface number | A4 | A6 | A8 | A10 | A12 |
|---|---|---|---|---|---|
| S1 | 1.7835E−02 | 1.0313E−01 | −7.7317E−01 | 3.9133E+00 | −1.1976E+01 |
| S2 | −2.3282E−01 | 2.2227E−02 | 3.2881E+00 | −1.8342E+01 | 6.7372E+01 |
| S3 | −2.5403E−01 | 1.0151E−01 | 4.5478E+00 | −2.6252E+01 | 9.1573E+01 |
| S4 | −1.1963E−01 | 8.6351E−01 | −5.9977E+00 | 3.7781E+01 | −1.5465E+02 |
| S5 | −3.4006E−01 | 1.2964E+00 | −1.2866E+01 | 7.8338E+01 | −3.0301E+02 |
| S6 | −2.6079E−01 | 6.4237E−01 | −4.4040E+00 | 1.8346E+01 | −4.8287E+01 |
| S7 | −5.4720E−02 | 5.6605E−02 | −5.1573E−01 | 1.2322E+00 | −1.5561E+00 |
| S8 | −2.2924E−01 | 3.6085E−01 | −6.4938E−01 | 8.0308E−01 | −5.9536E−01 |
| S9 | −3.9311E−01 | 1.8748E−01 | 1.9016E−02 | −4.9020E−02 | 2.1157E−02 |
| S10 | −1.7244E−01 | 8.5024E−02 | −1.7750E−02 | −2.5500E−03 | 2.5600E−03 |

| Surface number | A14 | A16 | A18 | A20 |
|---|---|---|---|---|
| S1 | 2.2674E+01 | −2.6143E+01 | 1.6835E+01 | −4.6983E+00 |
| S2 | −1.7168E+02 | 2.6936E+02 | −2.2818E+02 | 7.9275E+01 |
| S3 | −2.1547E+02 | 3.1789E+02 | −2.5862E+02 | 8.7543E+01 |
| S4 | 3.9197E+02 | −5.9991E+02 | 5.1050E+02 | −1.8560E+02 |
| S5 | 7.3535E+02 | −1.0865E+03 | 8.9103E+02 | −3.0981E+02 |
| S6 | 7.9923E+01 | −8.0694E+01 | 4.5408E+01 | −1.0830E+01 |
| S7 | 1.1570E+00 | −5.1183E−01 | 1.2571E−01 | −1.3250E−02 |
| S8 | 2.6977E−01 | −7.4060E−02 | 1.1370E−02 | −7.5000E−04 |
| S9 | −4.7600E−03 | 6.1400E−04 | −4.3000E−05 | 1.2900E−06 |
| S10 | −7.0000E−04 | 9.8700E−05 | −7.2000E−06 | 2.1700E−07 |

FIG. 7A shows a longitudinal aberration curve of the optical imaging lens assembly according to Embodiment 3 to represent deviations of a convergence focal point after lights with different wavelengths passes through the lens. FIG. 7B shows an astigmatism curve of the optical imaging lens assembly according to Embodiment 3 to represent a tangential image surface curvature and a sagittal image surface curvature. FIG. 7C shows a distortion curve of the optical imaging lens assembly according to Embodiment 3 to represent distortion values corresponding to different image heights. FIG. 7D shows a lateral color curve of the optical imaging lens assembly according to Embodiment 3 to represent deviations of different image heights on the imaging surface after the light passes through the lens. According to FIGS. 7A-7D, it can be seen that the optical imaging lens assembly provided in Embodiment 3 may achieve high imaging quality.

### Embodiment 4

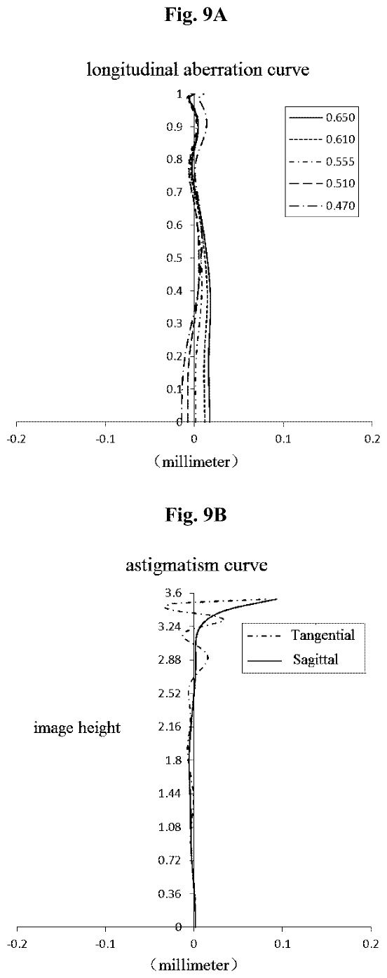

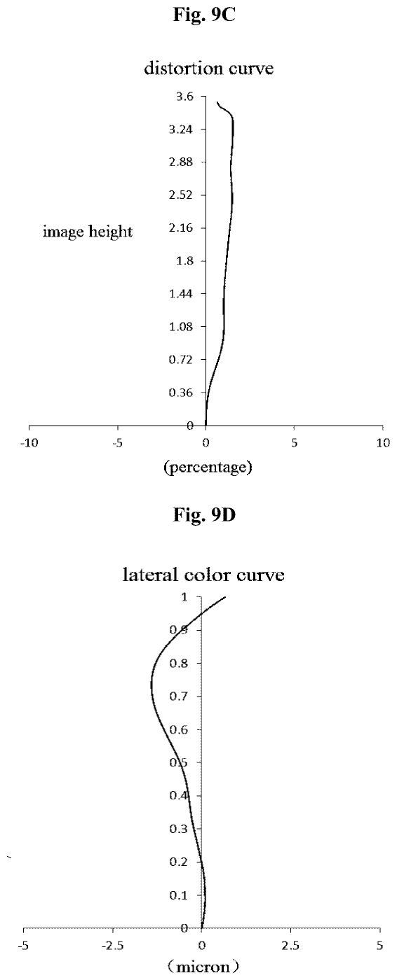

An optical imaging lens assembly according to Embodiment 4 of the disclosure is described below with reference to FIGS. 8-9D. FIG. 8 shows a structural schematic diagram of an optical imaging lens assembly according to Embodiment 4 of the disclosure.

As shown in FIG. 8, the optical imaging lens assembly sequentially includes from an object side to an image side along an optical axis: a diaphragm STO, a first lens E1, a second lens E2, a third lens E3, a fourth lens E4, a fifth lens E5 and an optical filter E6.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a concave surface, and an image-side surface S6 thereof is a convex surface. The fourth lens E4 has a positive refractive power, an object-side surface S7 thereof is a concave surface, and an image-side surface S8 thereof is a convex surface. The fifth lens E5 has a negative refractive power, an object-side surface S9 thereof is a convex surface, and an image-side surface S10 thereof is a concave surface. The optical filter E6 has an object-side surface S11 and an image-side surface S12. The optical imaging lens assembly has an imaging surface S13. Light from an object sequentially passes through each of the surfaces S1 to S12 and is finally imaged on the imaging surface S13.

In Embodiment 4, a value of a total effective focal length f of the optical imaging lens is 3.75 mm. TTL is an on-axis distance from the object-side surface S1 of the first lens E1 to the imaging surface S13, and a value of TTL is 4.29 mm. ImgH is a half of a diagonal length of an effective pixel region on the imaging surface S13, and a value of ImgH is 3.54 mm.

Table 7 shows a basic parameter table of the optical imaging lens assembly of Embodiment 4, wherein the units of the curvature radius, the thickness/distance and the focal length are all millimeters (mm). Table 8 shows high-order coefficients that may be used for each aspheric mirror surface in Embodiment 4. A surface type of each aspheric surface may be defined by formula (1) given in Embodiment 1.

TABLE 7

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −0.0888 | | | | |
| S1 | Aspheric | 1.3295 | 0.5341 | 1.55 | 56.1 | 3.29 | −0.3243 |
| S2 | Aspheric | 4.3728 | 0.0358 | | | | −16.3886 |
| S3 | Aspheric | 10.4909 | 0.2180 | 1.68 | 19.2 | −9.12 | 38.8694 |
| S4 | Aspheric | 3.8571 | 0.2959 | | | | 15.3607 |
| S5 | Aspheric | −53.1895 | 0.3160 | 1.55 | 56.1 | 44.63 | −96.0000 |
| S6 | Aspheric | −16.7466 | 0.5650 | | | | −96.0154 |
| S7 | Aspheric | −13.0272 | 0.4855 | 1.55 | 56.1 | 4.32 | −5.9012 |
| S8 | Aspheric | −2.0215 | 0.6386 | | | | −19.4038 |
| S9 | Aspheric | 180.8380 | 0.3400 | 1.54 | 55.7 | −2.62 | 48.3965 |
| S10 | Aspheric | 1.3943 | 0.3126 | | | | −8.2715 |
| S11 | Spherical | Infinite | 0.2100 | 1.52 | 64.2 | | |
| S12 | Spherical | Infinite | 0.3431 | | | | |
| S13 | Spherical | Infinite | | | | | |

TABLE 8

| Surface number | A4 | A6 | A8 | A10 | A12 |
|---|---|---|---|---|---|
| S1 | 2.0504E−02 | 7.4807E−02 | −5.0764E−01 | 2.5746E+00 | −7.7686E+00 |
| S2 | −2.5420E−01 | 3.7943E−01 | −3.2133E−01 | 3.3133E+00 | −1.2402E+01 |
| S3 | −2.8467E−01 | 3.8075E−01 | 2.4821E+00 | −1.5030E+01 | 5.1976E+01 |
| S4 | −1.3355E−01 | 9.4571E−01 | −6.7164E+00 | 4.4826E+01 | −1.9239E+02 |
| S5 | −3.5663E−01 | 1.3012E+00 | −1.3121E+01 | 8.1820E+01 | −3.2528E+02 |
| S6 | −2.7591E−01 | 7.0748E−01 | −4.9507E+00 | 2.1043E+01 | −5.6487E+01 |
| S7 | −7.6220E−02 | 1.4288E−01 | −8.9318E−01 | 2.0891E+00 | −2.6997E+00 |
| S8 | −2.6903E−01 | 4.6974E−01 | −8.8125E−01 | 1.1238E+00 | −8.6631E−01 |
| S9 | −4.0789E−01 | 2.1670E−01 | 1.4000E−03 | −4.5960E−02 | 2.1945E−02 |
| S10 | −1.8482E−01 | 1.0131E−01 | −2.8530E−02 | 1.7190E−03 | 1.5060E−03 |

| Surface number | A14 | A16 | A18 | A20 |
|---|---|---|---|---|
| S1 | 1.4240E+01 | −1.5617E+01 | 9.3502E+00 | −2.4040E+00 |
| S2 | 1.1866E+01 | 1.3686E+01 | −3.2768E+01 | 1.6854E+01 |
| S3 | −1.2598E+02 | 1.9413E+02 | −1.6479E+02 | 5.8067E+01 |
| S4 | 5.0731E+02 | −8.0289E+02 | 7.0288E+02 | −2.6175E+02 |
| S5 | 8.1270E+02 | −1.2368E+03 | 1.0453E+03 | −3.7476E+02 |
| S6 | 9.5491E+01 | −9.8565E+01 | 5.6795E+01 | −1.3910E+01 |
| S7 | 2.0854E+00 | −9.6047E−01 | 2.4464E−01 | −2.6600E−02 |
| S8 | 4.1029E−01 | −1.1795E−01 | 1.8961E−02 | −1.3100E−03 |
| S9 | −5.2100E−03 | 6.9800E−04 | −5.1000E−05 | 1.5500E−06 |
| S10 | −5.4000E−04 | 8.3800E−05 | −6.5000E−06 | 2.0000E−07 |

FIG. 9A shows a longitudinal aberration curve of the optical imaging lens assembly according to Embodiment 4 to represent deviations of a convergence focal point after lights with different wavelengths passes through the lens. FIG. 9B shows an astigmatism curve of the optical imaging lens assembly according to Embodiment 4 to represent a tangential image surface curvature and a sagittal image surface curvature. FIG. 9C shows a distortion curve of the optical imaging lens assembly according to Embodiment 4 to represent distortion values corresponding to different image heights. FIG. 9D shows a lateral color curve of the optical imaging lens assembly according to Embodiment 4 to represent deviations of different image heights on the imaging surface after the light passes through the lens. According to FIGS. 9A-9D, it can be seen that the optical imaging lens assembly provided in Embodiment 4 may achieve high imaging quality.

### Embodiment 5

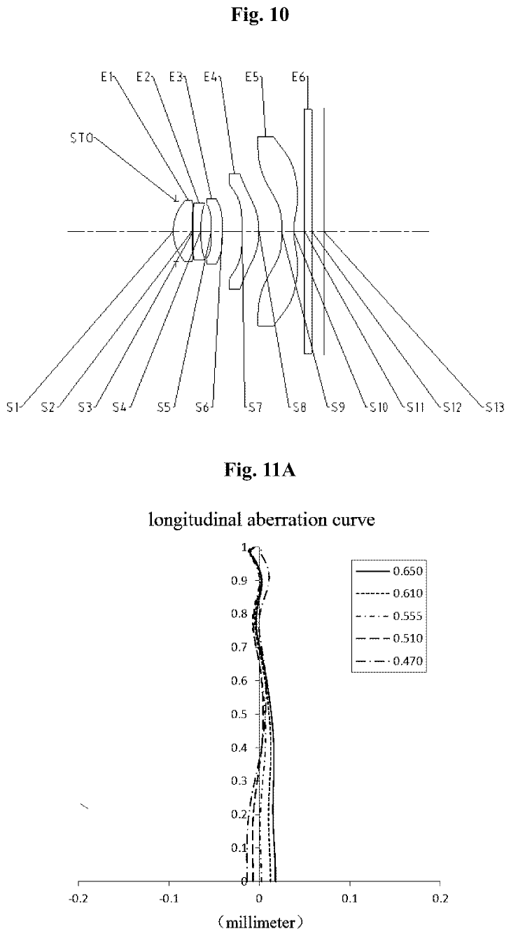

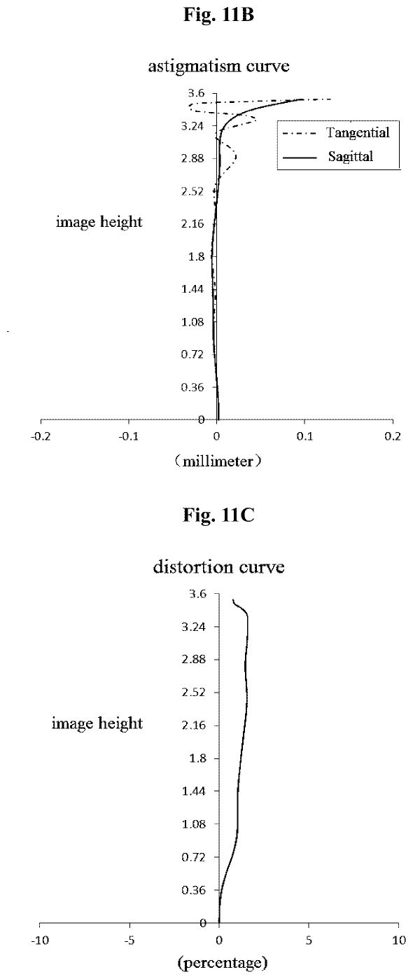

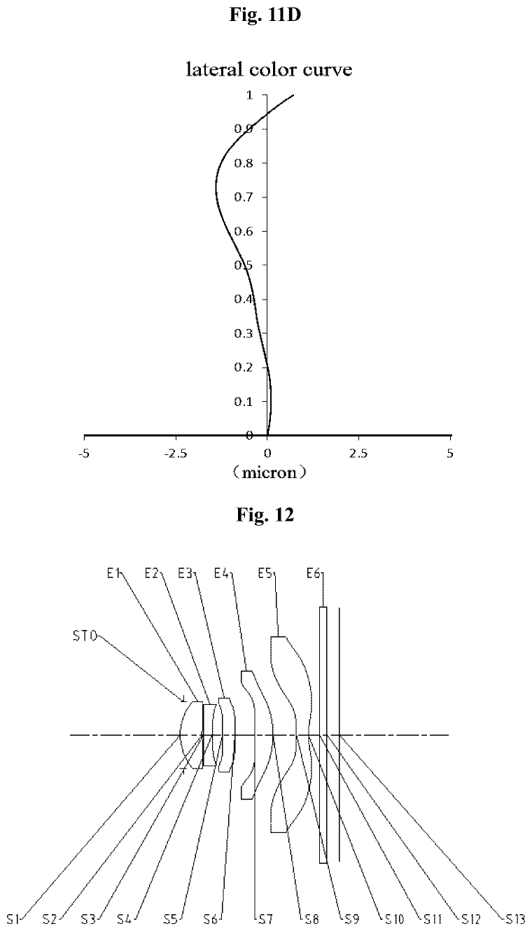

An optical imaging lens assembly according to Embodiment 5 of the disclosure is described below with reference to FIGS. 10-11D. FIG. 10 shows a structural schematic diagram of an optical imaging lens assembly according to Embodiment 5 of the disclosure.

As shown in FIG. 10, the optical imaging lens assembly sequentially includes from an object side to an image side along an optical axis: a diaphragm STO, a first lens E1, a second lens E2, a third lens E3, a fourth lens E4, a fifth lens E5 and an optical filter E6.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a concave surface, and an image-side surface S6 thereof is a convex surface. The fourth lens E4 has a positive refractive power, an object-side surface S7 thereof is a concave surface, and an image-side surface S8 thereof is a convex surface. The fifth lens E5 has a negative refractive power, an object-side surface S9 thereof is a convex surface, and an image-side surface S10 thereof is a concave surface. The optical filter E6 has an object-side surface S11 and an image-side surface S12. The optical imaging lens assembly has an imaging surface S13. Light from an object sequentially passes through each of the surfaces S1 to S12 and is finally imaged on the imaging surface S13.

In Embodiment 5, a value of a total effective focal length f of the optical imaging lens is 3.75 mm. TTL is an on-axis distance from the object-side surface S1 of the first lens E1 to the imaging surface S13, and a value of TTL is 4.29 mm. ImgH is a half of a diagonal length of an effective pixel region on the imaging surface S13, and a value of ImgH is 3.54 mm.

Table 9 shows a basic parameter table of the optical imaging lens assembly of Embodiment 5, wherein the units of the curvature radius, the thickness/distance and the focal length are all millimeters (mm). Table 10 shows high-order coefficients that can be used for each aspheric mirror surface in Embodiment 5. A surface type of each aspheric surface may be defined by formula (1) given in Embodiment 1.

TABLE 9

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −0.0828 | | | | |
| S1 | Aspheric | 1.3262 | 0.5299 | 1.55 | 56.1 | 3.29 | −0.3300 |
| S2 | Aspheric | 4.3488 | 0.0358 | | | | −16.9199 |
| S3 | Aspheric | 10.4937 | 0.2182 | 1.68 | 19.2 | −9.11 | 40.7119 |
| S4 | Aspheric | 3.8543 | 0.2952 | | | | 15.4136 |
| S5 | Aspheric | −60.5762 | 0.3175 | 1.55 | 56.1 | 43.54 | 95.0000 |
| S6 | Aspheric | −17.1040 | 0.5650 | | | | −93.9923 |
| S7 | Aspheric | −11.5503 | 0.4808 | 1.55 | 56.1 | 4.32 | −7.1567 |
| S8 | Aspheric | −1.9888 | 0.6427 | | | | −18.6825 |
| S9 | Aspheric | 6414.6450 | 0.3400 | 1.54 | 55.7 | −2.62 | 48.3965 |
| S10 | Aspheric | 1.4044 | 0.3125 | | | | −8.8453 |
| S11 | Spherical | Infinite | 0.2100 | 1.52 | 64.2 | | |
| S12 | Spherical | Infinite | 0.3430 | | | | |
| S13 | Spherical | Infinite | | | | | |

TABLE 10

| Surface number | A4 | A6 | A8 | A10 | A12 |
|---|---|---|---|---|---|
| S1 | 2.0707E−02 | 8.2572E−02 | −5.9867E−01 | 3.1063E+00 | −9.5526E+00 |
| S2 | −2.5380E−01 | 3.0565E−01 | 4.6676E−01 | −1.0890E+00 | 1.7521E+00 |
| S3 | −2.8407E−01 | 2.9331E−01 | 3.4027E+00 | −2.0128E+01 | 6.8916E+01 |
| S4 | −1.3603E−01 | 9.6318E−01 | −6.8874E+00 | 4.6135E+01 | −1.9857E+02 |
| S5 | −3.5776E−01 | 1.3225E+00 | −1.3560E+01 | 8.5639E+01 | −3.4397E+02 |
| S6 | −2.7944E−01 | 7.5341E−01 | −5.2853E+00 | 2.2480E+01 | −6.0393E+01 |
| S7 | −8.3440E−02 | 1.3805E−01 | −8.3191E−01 | 1.9550E+00 | −2.5536E+00 |
| S8 | −2.7909E−01 | 4.7649E−01 | −8.6258E−01 | 1.0898E+00 | −8.4109E−01 |
| S9 | −4.1943E−01 | 2.5619E−01 | −3.9350E−02 | −2.3980E−02 | 1.4843E−02 |
| S10 | −1.7799E−01 | 9.8454E−02 | −2.8280E−02 | 1.9930E−03 | 1.3600E−03 |

| Surface number | A14 | A16 | A18 | A20 |
|---|---|---|---|---|
| S1 | 1.7802E+01 | −1.9792E+01 | 1.1979E+01 | −3.0902E+00 |
| S2 | −1.4328E+01 | 4.1035E+01 | −4.7875E+01 | 2.0391E+01 |
| S3 | −1.6003E+02 | 2.3517E+02 | −1.9270E+02 | 6.6493E+01 |
| S4 | 5.2541E+02 | −8.3498E+02 | 7.3444E+02 | −2.7496E+02 |
| S5 | 8.6686E+02 | −1.3292E+03 | 1.1311E+03 | −4.0808E+02 |
| S6 | 1.0224E+02 | −1.0575E+02 | 6.1110E+01 | −1.5022E+01 |
| S7 | 1.9972E+00 | −9.3251E−01 | 2.4125E−01 | −2.6710E−02 |
| S8 | 4.0047E−01 | −1.1606E−01 | 1.8851E−02 | −1.3200E−03 |
| S9 | −3.7800E−03 | 5.2200E−04 | −3.8000E−05 | 1.1800E−06 |
| S10 | −5.0000E−04 | 7.9100E−05 | −6.1000E−06 | 1.9100E−07 |

FIG. 11A shows a longitudinal aberration curve of the optical imaging lens assembly according to Embodiment 5 to represent deviation of a convergence focal point after lights with different wavelengths passes through the lens. FIG. 11 B shows an astigmatism curve of the optical imaging lens assembly according to Embodiment 5 to represent a tangential image surface curvature and a sagittal image surface curvature. FIG. 11C shows a distortion curve of the optical imaging lens assembly according to Embodiment 5 to represent distortion values corresponding to different image heights. FIG. 11D shows a lateral color curve of the optical imaging lens assembly according to Embodiment 5 to represent deviation of different image heights on the imaging surface after the light passes through the lens. According to FIGS. 11A-11D, it can be seen that the optical imaging lens assembly provided in Embodiment 5 may achieve high imaging quality.

### Embodiment 6

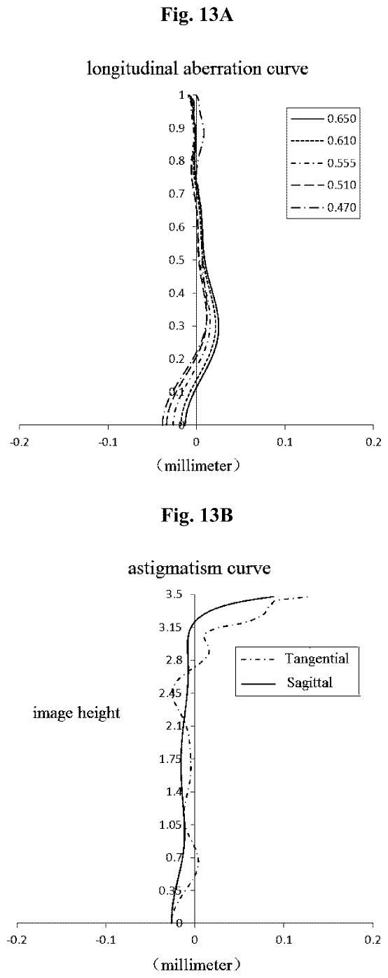

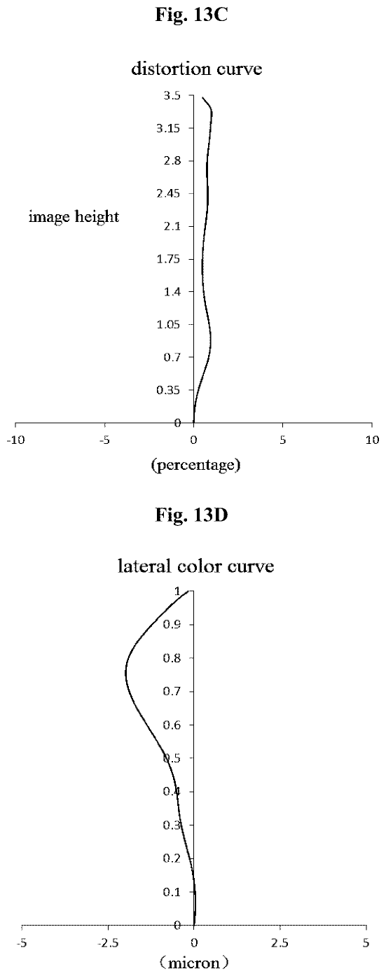

An optical imaging lens assembly according to Embodiment 6 of the disclosure is described below with reference to FIGS. 12-13D. FIG. 12 shows a structural schematic diagram of an optical imaging lens assembly according to Embodiment 6 of the disclosure.

As shown in FIG. 12, the optical imaging lens assembly sequentially includes from an object side to an image side along an optical axis: a diaphragm STO, a first lens E1, a second lens E2, a third lens E3, a fourth lens E4, a fifth lens E5 and an optical filter E6.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a positive refractive power, an object-side surface S7 thereof is a convex surface, and an image-side surface S8 thereof is a convex surface. The fifth lens E5 has a negative refractive power, an object-side surface S9 thereof is a concave surface, and an image-side surface S10 thereof is a concave surface. The optical filter E6 has an object-side surface S11 and an image-side surface S12. The optical imaging lens assembly has an imaging surface S13. Light from an object sequentially passes through each of the surfaces S1 to S12 and is finally imaged on the imaging surface S13.

In Embodiment 6, a value of a total effective focal length f of the optical imaging lens is 3.73 mm. TTL is an on-axis distance from the object-side surface S1 of the first lens E1 to the imaging surface S13, and a value of TTL is 4.35 mm. ImgH is a half of a diagonal length of an effective pixel region on the imaging surface S13, and a value of ImgH is 3.48 mm.

Table 11 shows a basic parameter table of the optical imaging lens assembly of Embodiment 6, wherein the units of the curvature radius, the thickness/distance and the focal length are all millimeters (mm). Table 12 shows high-order coefficients that can be used for each aspheric mirror surface in Embodiment 6. A surface type of each aspheric surface may be defined by formula (1) given in Embodiment 1.

TABLE 11

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −0.0894 | | | | |
| S1 | Aspheric | 1.4178 | 0.5966 | 1.55 | 56.1 | 3.39 | −0.3275 |
| S2 | Aspheric | 5.1418 | 0.0366 | | | | −9.3827 |
| S3 | Aspheric | 10.8203 | 0.2358 | 1.68 | 19.2 | −8.08 | −3.9258 |
| S4 | Aspheric | 3.6027 | 0.2828 | | | | 15.6151 |
| S5 | Aspheric | 8.9184 | 0.3408 | 1.55 | 56.1 | 24.64 | −47.5319 |
| S6 | Aspheric | 26.1124 | 0.5550 | | | | −15.9383 |
| S7 | Aspheric | 146.8561 | 0.4876 | 1.55 | 56.1 | 4.22 | 90.0000 |
| S8 | Aspheric | −2.3369 | 0.6418 | | | | −1.0917 |
| S9 | Aspheric | −17.4560 | 0.3240 | 1.54 | 55.7 | −2.57 | 48.3965 |
| S10 | Aspheric | 1.5097 | 0.3042 | | | | −7.8323 |
| S11 | Spherical | Infinite | 0.2100 | 1.52 | 64.2 | | |
| S12 | Spherical | Infinite | 0.3348 | | | | |
| S13 | Spherical | Infinite | | | | | |

TABLE 12

| Surface number | A4 | A6 | A8 | A10 | A12 |
|---|---|---|---|---|---|
| S1 | 4.2000E−03 | 1.4620E−01 | −7.6616E−01 | 2.5471E+00 | −4.9645E+00 |
| S2 | −2.5741E−01 | −1.1862E−01 | 6.8390E+00 | −4.2265E+01 | 1.5633E+02 |
| S3 | −3.0259E−01 | 5.0700E−04 | 8.3680E+00 | −5.2822E+01 | 1.8977E+02 |
| S4 | −1.6134E−01 | 2.6231E−01 | 7.7203E−01 | −2.6522E+00 | −6.4196E+00 |
| S5 | −3.8163E−01 | 1.9394E+00 | −1.5850E+01 | 8.0421E+01 | −2.5918E+02 |
| S6 | −2.4219E−01 | 4.5728E−01 | −2.8535E+00 | 1.1168E+01 | −2.8004E+01 |
| S7 | −2.7580E−02 | −8.8460E−02 | −3.1040E−02 | 1.2453E−01 | −4.0910E−02 |
| S8 | 3.1821E−02 | −1.3103E−01 | 1.4982E−01 | −1.1894E−01 | 8.2432E−02 |
| S9 | −4.0623E−01 | 1.8084E−01 | 5.4543E−02 | −7.9260E−02 | 3.3939E−02 |
| S10 | −2.3070E−01 | 1.4581E−01 | −5.8460E−02 | 1.6138E−02 | −3.1400E−03 |
| | Surface number | A14 | A16 | A18 | A20 |
| | S1 | 5.5305E+00 | −3.2435E+00 | 7.5679E−01 | −2.2300E−03 |
| | S2 | −3.6663E+02 | 5.1383E+02 | −3.8736E+02 | 1.2020E+02 |
| | S3 | −4.2821E+02 | 5.8255E+02 | −4.3089E+02 | 1.3228E+02 |
| | S4 | 4.6003E+01 | −9.9323E+01 | 1.0046E+02 | −4.0309E+01 |
| | S5 | 5.2860E+02 | −6.6218E+02 | 4.6449E+02 | −1.3906E+02 |
| | S6 | 4.4436E+01 | −4.3132E+01 | 2.3367E+01 | −5.3638E+00 |
| | S7 | −1.2382E−01 | 1.3877E−01 | −5.3830E−02 | 7.2790E−03 |
| | S8 | −3.9480E−02 | 1.1045E−02 | −1.6000E−03 | 9.1800E−05 |
| | S9 | −7.8900E−03 | 1.0670E−03 | −7.9000E−05 | 2.5100E−06 |
| | S10 | 4.1500E−04 | −3.5000E−05 | 1.7600E−06 | −4.1000E−08 |

FIG. 13A shows a longitudinal aberration curve of the optical imaging lens assembly according to Embodiment 6 to represent deviations of a convergence focal point after lights with different wavelengths passes through the lens. FIG. 13B shows an astigmatism curve of the optical imaging lens assembly according to Embodiment 6 to represent a tangential image surface curvature and a sagittal image surface curvature. FIG. 13C shows a distortion curve of the optical imaging lens assembly according to Embodiment 6 to represent distortion values corresponding to different image heights. FIG. 13D shows a lateral color curve of the optical imaging lens assembly according to Embodiment 6 to represent deviations of different image heights on the imaging surface after the light passes through the lens. According to FIGS. 13A-13D, it can be seen that the optical imaging lens assembly provided in Embodiment 6 may achieve high imaging quality.

From the above, Embodiment 1 to Embodiment 6 satisfy a relationship shown in Table 13 respectively.

TABLE 13

| Conditional | | | | | | |
|---|---|---|---|---|---|---|
| expression/embodiment | 1 | 2 | 3 | 4 | 5 | 6 |
| VP(mm) | 1.06 | 1.06 | 1.06 | 1.05 | 1.04 | 1.10 |
| f4/f1 | 1.15 | 1.13 | 1.26 | 1.31 | 1.31 | 1.24 |
| (f5 − f2)/f | 1.72 | 1.76 | 1.74 | 1.73 | 1.73 | 1.48 |
| TTL/lmgH | 1.25 | 1.23 | 1.22 | 1.21 | 1.21 | 1.25 |
| FOV(°) | 84.0 | 85.0 | 85.2 | 85.3 | 85.2 | 84.1 |
| EPD/lmgH | 0.51 | 0.50 | 0.50 | 0.49 | 0.49 | 0.52 |
| (R3 + R4)/(R1 + R2) | 1.98 | 2.06 | 2.25 | 2.52 | 2.53 | 2.20 |
| (R10 − R8)/f | 0.89 | 0.88 | 0.96 | 0.91 | 0.90 | 1.03 |
| (T34 + CT4)/(T45 + CT5) | 1.17 | 1.22 | 1.10 | 1.07 | 1.06 | 1.08 |
| 10 × DT11/lmgH | 2.54 | 2.50 | 2.50 | 2.49 | 2.47 | 2.63 |
| f12/(CT1 + CT2) | 6.10 | 6.15 | 6.04 | 6.11 | 6.14 | 6.06 |
| SAG52/SAG51 | 0.77 | 0.82 | 0.85 | 0.86 | 0.86 | 0.88 |
| DW(mm) | 1.92 | 1.95 | 1.95 | 1.94 | 1.91 | 1.98 |

The disclosure also provides an imaging device, which is provided with an electronic photosensitive element for imaging. The electronic photosensitive element may be a Charge Coupled Device (CCD) or a Complementary Metal Oxide Semiconductor (CMOS). The imaging device may be an independent imaging device such as a digital camera, or may be an imaging module integrated into a mobile electronic device such as a mobile phone. The imaging device is provided with the above-mentioned optical imaging lens assembly.

The above is only the description about the preferred embodiments of the disclosure and adopted technical principles. It is understood by those skilled in the art that the scope of protection involved in the disclosure is not limited to the technical solutions formed by specifically combining the technical features and should also cover other technical solutions formed by freely combining the technical features or equivalent characteristics thereof without departing from the concept of the disclosure, for example, technical solutions formed by mutually replacing the features and (but not limited to) the technical features with similar functions disclosed in the disclosure.

What is claimed is:

1. An optical imaging lens assembly, sequentially comprising from an object side to an image side along an optical axis:
a first lens with a positive refractive power, an object-side surface thereof is a convex surface, and an image-side surface thereof is a concave surface;
a second lens with a negative refractive power;
a third lens with a refractive power;
a fourth lens with a positive refractive power; and
a fifth lens with a negative refractive power;
wherein VP is an on-axis distance from an intersection point of a straight line where a marginal ray of the optical imaging lens assembly is located and the optical axis to the object-side surface of the first lens, and VP satisfies 0 mm<VP<1.5 mm.

2. The optical imaging lens assembly according to claim 1, wherein an effective focal length f4 of the fourth lens and an effective focal length f1 of the first lens satisfy 1.0<f4/f1<1.4.

3. The optical imaging lens assembly according to claim 1, wherein an effective focal length f2 of the second lens, an effective focal length f5 of the fifth lens and a total effective focal length f of the optical imaging lens assembly satisfy 1.4<(f5−f2)/f<1.8.

4. The optical imaging lens assembly according to claim 1, wherein TTL is a distance from the object-side surface of the first lens to an imaging surface of the optical imaging lens assembly on the optical axis, ImgH is a half of a diagonal length of an effective pixel region on the imaging surface, and TTL and ImgH satisfy TTL/ImgH<1.3.

5. The optical imaging lens assembly according to claim 1, wherein FOV is a maximum field of view of the optical imaging lens assembly, and FOV satisfies 82°<FOV<87°.

6. The optical imaging lens assembly according to claim 1, wherein EPD is an Entrance Pupil Diameter of the optical imaging lens assembly, ImgH is a half of a diagonal length of an effective pixel region on an imaging surface of the optical imaging lens assembly, and EPD and ImgH satisfy 0.4<EPD/ImgH<0.6.

7. The optical imaging lens assembly according to claim 1, wherein a curvature radius R1 of the object-side surface of the first lens, a curvature radius R2 of the image-side surface of the first lens, a curvature radius R3 of an object-side surface of the second lens and a curvature radius R4 of an image-side surface of the second lens satisfy 1.9<(R3+R4)/(R1+R2)<2.6.

8. The optical imaging lens assembly according to claim 1, wherein a total effective focal length f of the optical imaging lens assembly, a curvature radius R8 of an image-side surface of the fourth lens and a curvature radius R10 of an image-side surface of the fifth lens satisfy 0.7<(R10−R8)/f<1.2.

9. The optical imaging lens assembly according to claim 1, wherein a spacing distance T34 of the third lens and the fourth lens on the optical axis, a center thickness CT4 of the fourth lens on the optical axis, a spacing distance T45 of the fourth lens and the fifth lens on the optical axis and a center thickness CT5 of the fifth lens on the optical axis satisfy 1.0<(T34+CT4)/(T45+CT5)<1.3.

10. The optical imaging lens assembly according to claim 1, wherein ImgH is a half of a diagonal length of an effective pixel region on an imaging surface of the optical imaging lens assembly, and an effective semi-diameter DT11 of the object-side surface of the first lens and ImgH satisfy 2.3<10×DT11/ImgH<2.8.

11. The optical imaging lens assembly according to claim 1, wherein a combined focal length f12 of the first lens and the second lens, a center thickness CT1 of the first lens on the optical axis and a center thickness CT2 of the second lens on the optical axis satisfy 6.0<f12/(CT1+CT2)<6.5.

12. The optical imaging lens assembly according to claim 1, wherein a window diameter DW of the optical imaging lens assembly satisfies 1.5 mm<DW<2.0 mm.

13. The optical imaging lens assembly according to claim 1, wherein SAG51 is an on-axis distance from an intersection point of an object-side surface of the fifth lens and the optical axis to an effective radius vertex of the object-side surface of the fifth lens, SAG52 is an on-axis distance from an intersection point of an image-side surface of the fifth lens and the optical axis to an effective radius vertex of the image-side surface of the fifth lens, and SAG51 and SAG52 satisfy 0.7<SAG52/SAG51<0.9.

14. An optical imaging lens assembly, sequentially comprising from an object side to an image side along an optical axis:
a first lens with a positive refractive power, an object-side surface thereof is a convex surface, and an image-side surface thereof is a concave surface;
a second lens with a negative refractive power;
a third lens with a refractive power;
a fourth lens with a positive refractive power; and
a fifth lens with a negative refractive power,
wherein a window diameter DW of the optical imaging lens assembly satisfies 1.5 mm<DW<2.0 mm.

15. The optical imaging lens assembly according to claim 14, wherein an effective focal length f4 of the fourth lens and an effective focal length f1 of the first lens satisfy 1.0<f4/f1<1.4.

16. The optical imaging lens assembly according to claim 14, wherein an effective focal length f2 of the second lens, an effective focal length f5 of the fifth lens and a total effective focal length f of the optical imaging lens assembly satisfy 1.4<(f5−f2)/f<1.8.

17. The optical imaging lens assembly according to claim 14, wherein TTL is a distance from the object-side surface of the first lens to an imaging surface of the optical imaging lens assembly on the optical axis, ImgH is a half of a diagonal length of an effective pixel region on the imaging surface, and TTL and ImgH satisfy TTL/ImgH<1.3.

18. The optical imaging lens assembly according to claim 14, wherein FOV is a maximum field of view of the optical imaging lens assembly, and FOV satisfies 82°<FOV<87°.

19. The optical imaging lens assembly according to claim 14, wherein EPD is an Entrance Pupil Diameter of the optical imaging lens assembly, ImgH is a half of a diagonal length of an effective pixel region on an imaging surface of the optical imaging lens assembly, and EPD and ImgH satisfy 0.4<EPD/ImgH<0.6.

20. The optical imaging lens assembly according to claim 14, wherein a curvature radius R1 of the object-side surface of the first lens, a curvature radius R2 of the image-side surface of the first lens, a curvature radius R3 of an object-side surface of the second lens and a curvature radius R4 of an image-side surface of the second lens satisfy 1.9<(R3+R4)/(R1+R2)<2.6.

21. (canceled)

22. (canceled)

23. (canceled)

24. (canceled)

25. (canceled)

26. (canceled)
